(19) United States
(12) Patent Application Publication
(10) Pub. No.: US 2023/0204955 A1
(43) Pub. Date: Jun. 29, 2023

(54) HEAD UP DISPLAY SYSTEM

(71) Applicant: FUYAO GLASS INDUSTRY GROUP CO., LTD., Fuqing (CN)

(72) Inventors: Fai TSO, Fuqing (CN); Lishan HE, Fuqing (CN); Dong ZENG, Fuqing (CN); Xiaorong ZHANG, Fuqing (CN); Fengzhu HUANG, Fuqing (CN); Guofu CHEN, Fuqing (CN); Kohta FUKUHARA, Fuqing (CN)

(73) Assignee: FUYAO GLASS INDUSTRY GROUP CO., LTD., Fuqing,Fujian (CN)

(21) Appl. No.: 18/118,295

(22) Filed: Mar. 7, 2023

Related U.S. Application Data
(63) Continuation of application No. PCT/CN2021/129114, filed on Nov. 5, 2021.

(30) Foreign Application Priority Data
Mar. 29, 2021 (CN) 202110330372.0

(51) Int. Cl. G02B 27/01; B32B 17/10; B32B 7/12

(52) U.S. Cl. CPC G02B 27/0101; B32B 17/10064; B32B 17/1022; B32B 17/10541; B32B 17/10568; B32B 7/12; G02B 2027/0116; G02B 2027/012; B60K 35/00

(57) ABSTRACT

A Head up display system includes a projection light source, laminated glass, and a transparent nano film. The transparent nano film includes at least one laminated structure consisting of a high refractive-index layer and a low refractive-index layer, where the high refractive-index layer and the low refractive-index layer is deposited sequentially outwards from the surface of the inner glass pane. The projection light source is configured to generate P-polarized light. A ratio of near-red light reflectivity R1 at wavelengths ranging from 580 nm to 680 nm of the laminated glass with the transparent nano film to near-blue light reflectivity R2 at wavelengths ranging from 420 nm to 470 nm of the laminated glass with the transparent nano film is R1/R2=1.0˜2.0.

### CROSS-REFERENCE TO RELATED APPLICATION(S)

This application is a continuation of International Application No. PCT/CN2021/129114, filed Nov. 5, 2021, which claims priority to Chinese Patent Application No. 202110330372.0, filed Mar. 29, 2021, the entire disclosures of which are hereby incorporated by reference.

### TECHNICAL FIELD

This disclosure relates to the field of a head up display technology, and more particularly to a Head up display system with a transparent nano film for image display, and the disclosure specifically provides a Head up display system capable of eliminating deficiencies of Head up display images such as being reddish or yellowish.

### BACKGROUND

A Head up display (HUD) system is increasingly configured on a vehicle, such that important driving information such as speed, engine revolutions per minute (rpm), fuel consumption, tire pressure, navigation, and information from an external smart device, can be displayed in real time on a front windshield in a field of view of a driver. As such, the driver does not need to look down to see the driving information, thereby avoiding distraction from a road ahead. Moreover, the driver does not need to adjust the line of sight between a distant road and near instrumentation, which can avoid eye strain, greatly enhance driving safety, and improve driving experience.

The Head up display system also has a problem of ghosting along with projected information display, i.e., there may be a secondary image that can be recognized by human eyes in addition to a main image observed by the human eyes. In order to mitigate or remove the secondary image, a traditional method is to use wedge-shaped laminated glass as a front windshield. For example, use of wedge-shaped polyvinyl butyral (PVB) as an intermediate layer of laminated glass or one glass pane of the laminated glass having a wedge-shaped cross section is disclosed in patents CN105793033B, CN111417518A, and CN110709359A.

P-polarized light and a conductive coating are also used to generate HUD images in the prior art such as patent DE102014220189A1 and Chinese patents CN110520782A, CN111433022A, and CN111433023A. As such, functions such as heat insulation and/or electric heating can also be implemented at the same time when a Head up display function is implemented, and therefore higher optical and electrical performance of the conductive coating are both required. In actual product application, it has been found that the HUD images generated by reflection of the P-polarized light are prone to color shift, which makes the HUD images have deficiencies such as being reddish or yellowish, thus seriously affecting beauty and quality of the HUD images.

### SUMMARY

A Head up display system is provided in the disclosure. The Head up display system includes a projection light source, laminated glass, and a transparent nano film. The laminated glass includes an outer glass pane, an inner glass pane, and an intermediate adhesive layer sandwiched between the outer glass pane and the inner glass pane. The transparent nano film is deposited on a surface of the inner glass pane away from the intermediate adhesive layer. The transparent nano film includes at least one laminated structure consisting of a high refractive-index layer and a low refractive-index layer, where the high refractive-index layer and the low refractive-index layer are deposited sequentially outwards from the surface of the inner glass pane. The high refractive-index layer has a refractive index greater than or equal to 1.8, and the low refractive-index layer has a refractive index less than or equal to 1.6. The projection light source is configured to generate P-polarized light, where the P-polarized light is incident on the transparent nano film at an angle of incidence ranging from 55° to 75°. The laminated glass with the transparent nano film has a reflectivity for the P-polarized light greater than or equal to 8%. A ratio of near-red light reflectivity R1 at wavelengths ranging from 580 nm to 680 nm of the laminated glass with the transparent nano film to near-blue light reflectivity R2 at wavelengths ranging from 420 nm to 470 nm of the laminated glass with the transparent nano film is R1/R2=1.0˜2.0.

### BRIEF DESCRIPTION OF THE DRAWINGS

FIG. 1 is a schematic structural diagram illustrating a Head up display system in the disclosure.

FIG. 2A is a schematic structural diagram illustrating a transparent nano film with one laminated structure in the disclosure.

FIG. 2B is a schematic structural diagram illustrating a transparent nano film with two laminated structures in the disclosure.

FIG. 2C is a schematic structural diagram illustrating a transparent nano film with three laminated structures in the disclosure.

FIG. 3A is a schematic structural diagram illustrating a transparent nano film with a high refractive-index layer including two sub-layers in the disclosure.

FIG. 3B is a schematic structural diagram illustrating a transparent nano film with a low refractive-index layer including two sub-layers in the disclosure.

FIG. 3C is a schematic structural diagram illustrating a transparent nano film with a high refractive-index layer including three sub-layers in the disclosure.

FIG. 4A is a schematic structural diagram illustrating another HUD system in the disclosure.

FIG. 4B is a schematic structural diagram illustrating another HUD system in the disclosure.

FIG. 5 is a schematic structural diagram illustrating another HUD system in the disclosure.

### DETAILED DESCRIPTION

The following will further illustrate contents in the disclosure with reference to accompanying drawings.

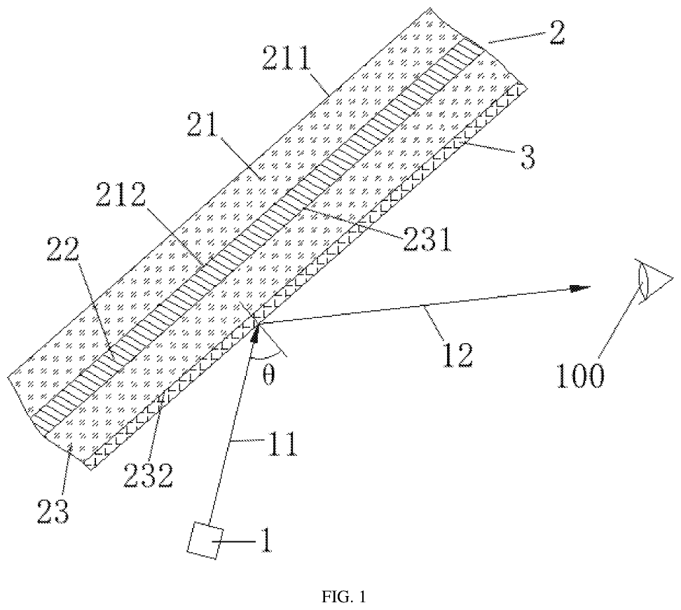

As illustrated in FIG. 1, a Head up display system in the disclosure includes a projection light source 1 and laminated glass 2. The laminated glass 2 includes an outer glass pane 21, an inner glass pane 23, and an intermediate adhesive layer 22 sandwiched between the outer glass pane 21 and the inner glass pane 23. The Head up display system further includes a transparent nano film 3 for removing ghosting, where the transparent nano film 3 is deposited on a surface of the inner glass pane 23 away from the intermediate adhesive layer 22, where the surface is denoted as a fourth surface 232. The projection light source 1 is configured to generate P-polarized light 11, where the P-polarized light 11 is incident on the transparent nano film 3 at an angle of incidence ranging from 55° to 75°. The laminated glass 2 with the transparent nano film 3 has a reflectivity for the P-polarized light 11 greater than or equal to 8%. In the disclosure, when the P-polarized light 11 is incident at the angle of incidence ranging from 55° to 75°, a reflectivity for the P-polarized light 11 is lower at a glass-air interface while is higher at the transparent nano film 3, such that only a reflected image from the transparent nano film will be observed as a main image when visually observing reflected images on the laminated glass, thereby removing visual ghosting.

In the disclosure, the outer glass pane 21 has a first surface 211 and a second surface 212. The first surface 211 is disposed facing an outside of a vehicle and away from the intermediate adhesive layer 22, and the second surface 212 is close to the intermediate adhesive layer 22. The inner glass pane 23 has a third surface 231 and the fourth surface 232. The third surface 231 is close to the intermediate adhesive layer 22, and the fourth surface 232 is disposed facing an inside of the vehicle and away from the intermediate adhesive layer 22. The second surface 212 and the third surface 231 are bonded through the intermediate adhesive layer 22 to form the laminated glass 2.

The intermediate adhesive layer 22 can be made of at least one of polycarbonate (PC), polyvinyl chloride (PVC), polyvinyl butyral (PVB), ethylene vinyl acetate (EVA), polyacrylate (PA), polymethyl methacrylate (PMMA), ionic interlayer (SGP), polyurethane (PU), etc. Preferably, a difference between a refractive index of the intermediate adhesive layer 22 and a refractive index of the inner glass pane 23 is less than or equal to 0.1, to obtain higher-quality Head up display images. The intermediate adhesive layer 22 may be a single-layer structure or a multi-layer structure, where the multi-layer structure may exemplarily include a double-layer structure, three-layer structure, four-layer structure, and five-layer structure. The intermediate adhesive layer 22 may also have other functions, e.g., reduction of interference of sunlight to human eyes by setting at least one colored area as a shadow band, sun protection or heat insulation by adding infrared absorbents, ultraviolet (UV) insulation by adding UV absorbents, or sound insulation by adding more plasticizers to one of the intermediate adhesive layer 22 of the multi-layer structure. In order to remove transmitted ghosting generated by a scenery in an external environment of the vehicle through a windshield, preferably, the intermediate adhesive layer 22 has a wedge-shaped cross-sectional profile, and the wedge-shaped cross-sectional profile has a wedge angle ranging from 0.01 milli-radians (mrad) to 0.18 mrad, e.g., 0.01 mrad, 0.02 mrad, 0.03 mrad, 0.04 mrad, 0.05 mrad, 0.06 mrad, 0.07 mrad, 0.08 mrad, 0.09 mrad, 0.10 mrad, 0.11 mrad, 0.12 mrad, 0.13 mrad, 0.14 mrad, 0.15 mrad, 0.16 mrad, 0.17 mrad, or 0.18 mrad. As such, by using merely the intermediate adhesive layer 22 with a smaller wedge angle, both reflected ghosting and transmitted ghosting can be removed at low-cost, thereby obtaining a higher-quality Head up display image and a better observation effect.

In FIG. 1, the P-polarized light 11 generated by the projection light source 1 is incident on the transparent nano film 3 at the angle of incidence θ ranging from 55° to 75°, and the transparent nano film 3 will directly reflect part of the P-polarized light 11 as reflected light 12. The reflected light 12 can directly enter into eyes of an observer 100 to form a Head up display main image. Since the transparent nano film 3 is relatively thin and the angle of incidence θ is close to the Brewster angle (about 57°), the part of the P-polarized light 11 incident into the transparent nano film 3 is basically un-reflected on the fourth surface 232 and has a basically unchanged propagation direction. Reflected light of the P-polarized light entered the laminated glass 2 then enters the eyes of the observer 100 but has an intensity being weak and even close to zero, such that ghosting can hardly be observed by the observer 100. In this case, the Head up display image is clear without visual ghosting and thus has a better display effect.

The projection light source 1 is configured to output on the laminated glass 2 relevant texts and image information, such as speed, engine revolutions per minute (rpm), fuel consumption, tire pressure, dynamic navigation, night vision, or live map, which then can be observed by the observer 100 in the vehicle, therefore implementing Head up display, and even strengthening augmented reality-HUD (AR-HUD). The projection light source 1 is a component known to those skilled in the art, which includes, but is not limited to, a laser, a light-emitting diode (LED), a liquid crystal display (LCD), digital light processing (DLP), electroluminescent (EL), a cathode ray tube (CRT), a vacuum fluorescent tube (VFD), a collimator lens, a spherical correction mirror, a convex lens, a concave lens, a reflection mirror, and/or a polarizer. In this case, a position and an angle of incidence of the projection light source 1 are adjustable to be adapted to different positions or heights of observers 100 in the vehicle.

The laminated glass 2 with the transparent nano film 3 can directly reflect at least 8% of the P-polarized light 11 to form the Head up display main image. The transparent nano film 3 specifically includes at least one laminated structure consisting of a high refractive-index layer 31 and a low refractive-index layer 32, where the high refractive-index layer 31 and the low refractive-index layer 32 is deposited sequentially outwards from the fourth surface 232 of the inner glass pane 23. The high refractive-index layer 31 has a refractive index greater than or equal to 1.8. Preferably the refractive index is greater than or equal to 2.0. More preferably the refractive index is greater than or equal to 2.2. Furthermore, the high refractive-index layer 31 may be made of at least one of: oxides of zinc (Zn), stannum (Sn), titanium (Ti), niobium (Nb), zirconium (Zr), nickel (Ni), indium (In), aluminium (Al), cerium (Ce), tungsten (W), molybdenum (Mo), antimony (Sb), or bismuth (Bi) or mixtures thereof, or nitrides or nitrogen oxides of silicon (Si), Al, Zr, yttrium (Y), Ce, or lanthanum (La) or mixtures thereof, which specifically may be TiOₓ, NbOₓ, HfO₂, ZnSnOₓ, TaOₓ, MoOₓ, ZrOₓ, CeO₂, WO₃, BiOₓ, or SiZrNₓ. The low refractive-index layer 32 has a refractive index less than or equal to 1.6. Preferably the refractive index is less than or equal to 1.5. Furthermore, the low refractive-index layer 32 may be made of at least one of SiO₂, Al₂O₃, or mixtures thereof, which specifically may be SiAlOₓ.

Preferably, the reflectivity of the laminated glass 2 with the transparent nano film 3 for the P-polarized light 11 is greater than or equal to 15%. Specifically, for the laminated glass 2 with the transparent nano film 3, a ratio of near-red light reflectivity R1 at wavelengths ranging from 580 nm to 680 nm to near-blue light reflectivity R2 at wavelengths ranging from 420 nm to 470 nm is R1/R2=1.0˜2.0, e.g., 1.0, 1.1, 1.2, 1.3, 1.4, 1.5, 1.6, 1.7, 1.8, 1.9, or 2.0. More preferably R1/R2=1.07˜1.9. As such, more P-polarized light can be reflected to obtain higher-quality Head up display images.

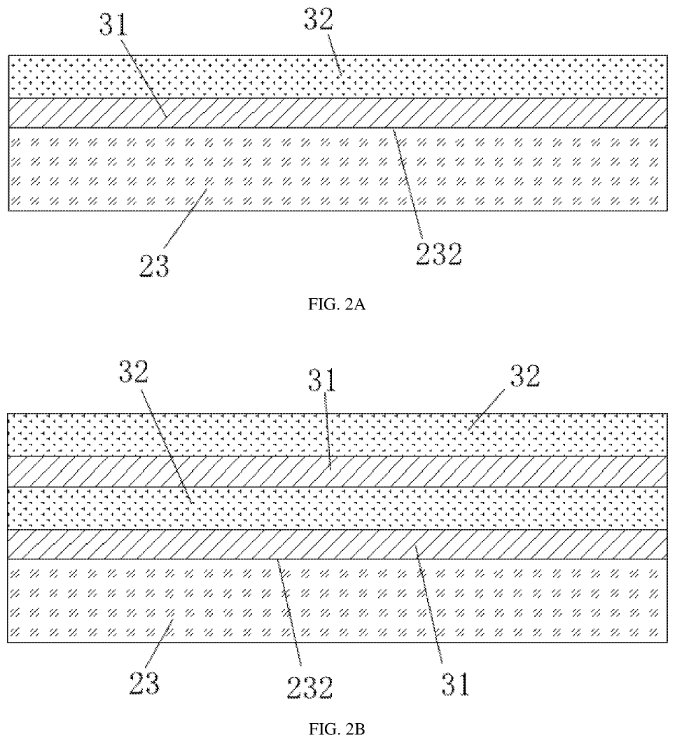

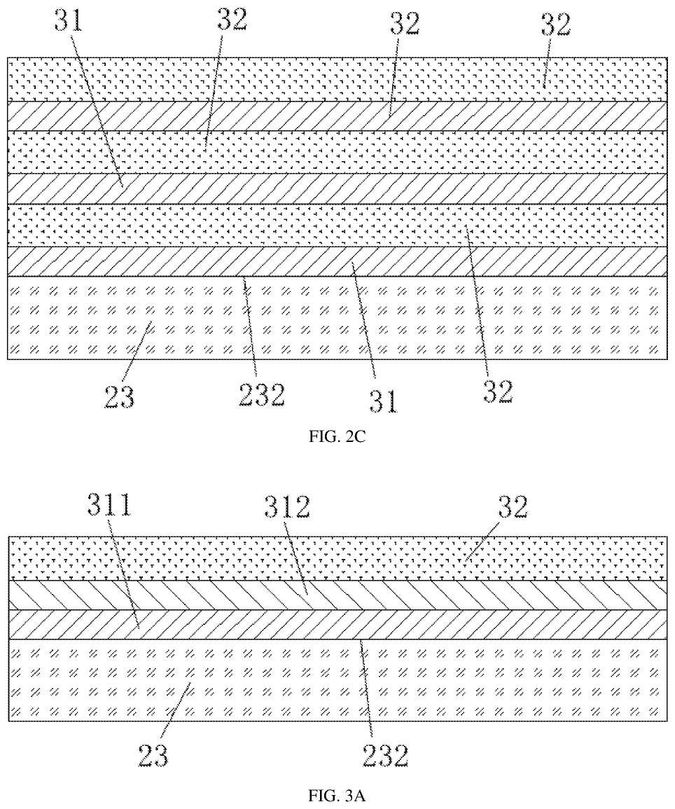

As illustrated in FIG. 2A, for example, the transparent nano film 3 includes one laminated structure consisting of a high refractive-index layer 31 and a low refractive-index layer 32, i.e., the inner glass panel 23 and layers of the laminated structure are arranged in an order of the inner glass pane 23/the high refractive-index layer 31/the low refractive-index layer 32 (similarly, character “/” is used to indicate the order of the panel, layers and the like in the following examples). As illustrated in FIG. 2B, for example, the transparent nano film 3 includes two laminated structures each consisting of a high refractive-index layer 31 and a low refractive-index layer 32, i.e., the inner glass pane 23/a first high refractive-index layer 31/a first low refractive-index layer 32/a second high refractive-index layer 31/a second low refractive-index layer 32. As illustrated in FIG. 2C, for example, the transparent nano film 3 includes three laminated structures each consisting of a high refractive-index layer 31 and a low refractive-index layer 32, i.e., the inner glass pane 23/a first high refractive-index layer 31/a first low refractive-index layer 32/a second high refractive-index layer 31/a second low refractive-index layer 32/a third high refractive-index layer 31/a third low refractive-index layer 32. For another example, the transparent nano film 3 may include four laminated structures each consisting of a high refractive-index layer 31 and a low refractive-index layer 32, i.e., the inner glass pane 23/a first high refractive-index layer/a first low refractive-index layer/a second high refractive-index layer/a second low refractive-index layer/a third high refractive-index layer/a third low refractive-index layer/a fourth high refractive-index layer/a fourth low refractive-index layer. In this way, the transparent nano film 3 can have excellent mechanical, chemical, and thermal stability and ensure excellent durability with the reasonably-designed film-layer materials and film-layer thicknesses of the high-refractive index layer and the low-refractive index layer. Preferably, the reflectivity of the transparent nano film 3 for the P-polarized light 11 is greater than or equal to 20%, thereby obtaining higher-quality Head up display images. Specifically, at least one high refractive-index layer has a refractive index greater than or equal to 2.5 and a thickness ranging from 45 nm to 75 nm.

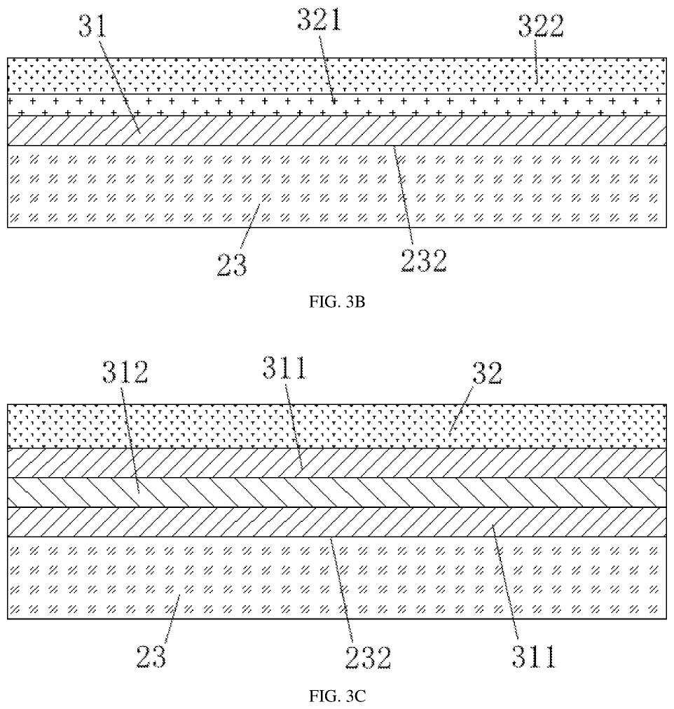

In the laminated structure consisting of the high refractive-index layer 31 and the low refractive-index layer 32, the high refractive-index layer 31 and/or the low refractive-index layer 32 may further include at least two sub-layers, i.e., the high refractive-index layer 31 includes at least two high refractive-index sub-layers, and the low refractive-index layer 32 includes at least two low refractive-index sub-layers. As illustrated in FIG. 3A, for example, the high refractive-index layer 31 includes a first high refractive-index sub-layer 311 and a second high refractive-index sub-layer 312, i.e., the inner glass pane 23/the first high refractive-index sub-layer 311/the second high refractive-index sub-layer 312/the low refractive-index layer 32. Preferably, a sub-layer in the high refractive-index layer 31 close to the inner glass pane 23, i.e., the first high refractive-index sub-layer 311, has a refractive index lower than a sub-layer in the high refractive-index layer 31 away from the inner glass pane 23, i.e., the second high refractive-index sub-layer 312. As illustrated in FIG. 3B, for example, the low refractive-index layer 32 includes a first low refractive-index layer 321 and a second low refractive-index layer 322, i.e., the inner glass pane 23/the high refractive-index layer 31/the first low refractive-index sub-layer 321/the second low refractive-index layer 322. For another example, the high refractive-index layer 31 includes a first high refractive-index sub-layer and a second high refractive-index sub-layer, and the low refractive-index layer 32 includes a first low refractive-index sub-layer and a second low refractive-index sub-layer, i.e., the inner glass pane 23/the first high refractive-index sub-layer/the second high refractive-index sub-layer/the first low refractive-index sub-layer/the second low refractive-index sub-layer.

If the high refractive-index layer 31 includes at least two high refractive-index sub-layers, preferably, at least one of the at least two high refractive-index sub-layers has a refractive index greater than or equal to 2.5, and at least another of the at least two high refractive-index sub-layers has a refractive index ranging from 1.8 to 2.2, where the at least another high refractive-index sub-layer with the refractive index ranging from 1.8 to 2.2 is more closer to the fourth surface 232 of the inner glass pane 23 than the at least one high refractive-index sub-layer with the refractive index greater than or equal to 2.5. As illustrated in FIG. 3C, for example, the high refractive-index layer 31 includes three high refractive-index sub-layers, i.e., two first high refractive-index sub-layers 311 and one second high refractive-index sub-layer 312. Each of the two first high refractive-index sub-layers 311 has a refractive index ranging from 1.8 to 2.2, and the second high refractive-index sub-layer 312 has a refractive index greater than or equal to 2.5. The second high refractive-index sub-layer 312 is disposed between the two first high refractive-index sub-layers 311. That is, a specific structure of the high refractive-index layer 31 is the first high refractive-index sub-layer 311/the second high refractive-index sub-layer 312/the first high refractive-index sub-layer 311. Preferably, the refractive index of the second high refractive-index sub-layer 312 is at least 0.5 greater than that of each of the two first high refractive-index sub-layers 311, thereby reflecting more P-polarized light to obtain higher-quality Head up display images.

For better eliminating deficiencies of Head up display images such as being reddish or yellowish, in the disclosure, preferably, in the P-polarized light 11 incident on the transparent nano film 3, a ratio of proportion T1 of near-red light with the wavelengths ranging from 580 nm to 680 nm to proportion T2 of near-blue light with the wavelengths ranging from 420 nm to 470 nm is T1/T2=0.1˜0.9, such as 0.1, 0.2, 0.3, 0.4, 0.5, 0.6, 0.7, 0.8, or 0.9, more preferably T1/T2=0.4˜0.8. According to a chromaticity theory, tri-stimulus values X, Y, Z of a color of any object R (λ) under a given illumination source S (λ) satisfy the following expressions:

X=k∫₃₈₀⁷⁸⁰S(λ)*R(λ)*X̅(λ)*dλ

Y=k∫₃₈₀⁷⁸⁰S(λ)*R(λ)*Y̅(λ)*dλ

Z=k∫₃₈₀⁷⁸⁰S(λ)*R(λ)*Z̅(λ)*dλ,

where k is an adjustment factor, R(λ) is a spectral reflectivity of an object, S(λ) is relative spectral power distribution of a light source, X̅(λ), Y̅(λ), and Z̅(λ) are spectral tri-stimulus values calculated from the international commission on illumination (CIE) standard observer, and dλ is a wavelength interval. As can be known from the above expressions, in the disclosure, relative spectral power distribution of the P-polarized light 11 incident on the transparent nano film 3 is improved on the basis of the ratio R1/R2 of near-red light reflectivity R1 of the laminated glass 2 with the transparent nano film 3 to near-blue light reflectivity R2 of the laminated glass 2 with the transparent nano film 3, thereby eliminating deficiencies of Head up display images such as being reddish or yellowish, and generating the Head up display images in neutral color, and thus the Head up display images can be more colorful to implement full-color display, for example, to display marks or symbols in different colors such as red, green, blue, yellow, orange, or white in a Head up display image at the same time. Moreover, in the disclosure, full-color display can be implemented without strict control of a ratio of synthetic light in a projection light source, thereby implementing full-color display at a lower cost and reducing a cost of a selected projection light source.

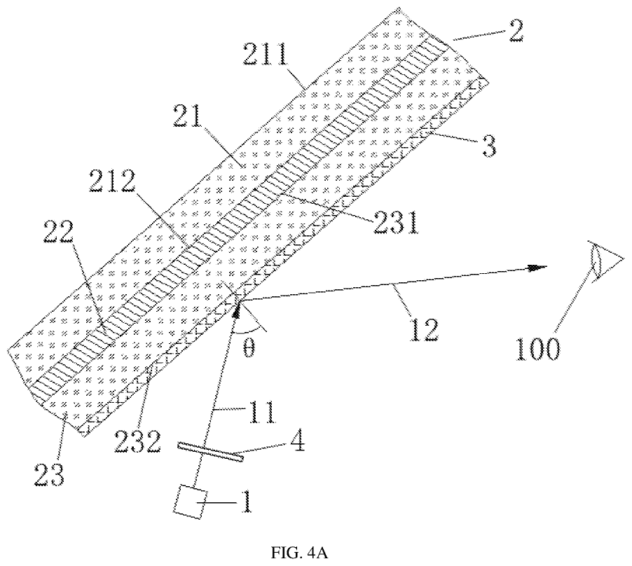

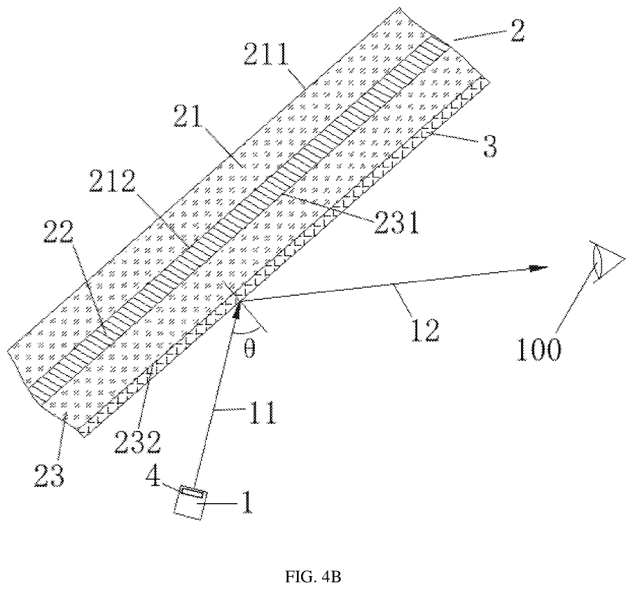

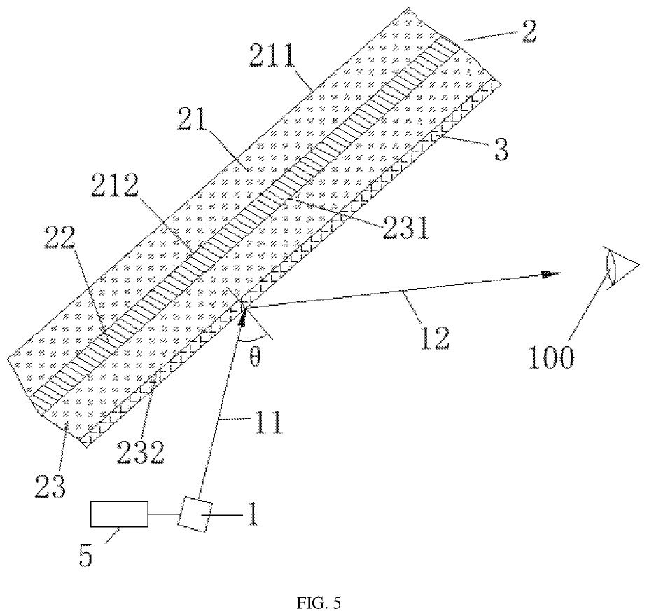

For improving the relative spectral power distribution of the P-polarized light 11 incident on the transparent nano film 3, in the disclosure, preferably, the Head up display system further includes a light-filtering component and/or is configured to perform a color filtering processing algorithm, which are used to make the ratio of proportion T1 of near-red light with the wavelengths ranging from 580 nm to 680 nm in the P-polarized light 11 incident on the transparent nano film 3 to proportion T2 of near-blue light with the wavelengths ranging from 420 nm to 470 nm in the P-polarized light 11 incident on the transparent nano film 3 to be T1/T2=0.1˜0.9. In an example, as illustrated in FIG. 4A, the light-filtering component 4 is located on an optical path of the P-polarized light, and the light-filtering component 4 has a transmittance for the P-polarized light greater than or equal to 80%. For example, the light-filtering component may be a filter, a filter film, a film, a filter lens, or a micro-nano array. In another example, as illustrated in FIG. 4B, the light-filtering component 4 can be located inside of the projection light source 1. In other examples, the light-filtering component 4 may be located between the projection light source 1 and the laminated glass 2. The Head up display system further includes a projection control system 5. As illustrated in FIG. 5, the projection control system 5 is coupled with the projection light source 1 and is used to control the projection light source 1 to generate the P-polarized light 11. The projection control system 5 can perform a color filtering processing algorithm. The P-polarized light 11 generated by the projection light source 1 is processed with the color filtering processing algorithm in a digital image processing technology, where the color filtering processing algorithm may exemplarily be a linear method, a non-linear method, a masking method, a color compensation method, or a color correction method.

For satisfying safety requirements for use of vehicle glasses, the outer glass pane 21 is a bent glass pane with a thickness greater than or equal to 1.8 mm, e.g., the bent glass pane is obtained through high-temperature heat treatment of at least 560° C. and bending molding. The inner glass pane 23 can also be a bent glass pane through high-temperature heat treatment of at least 560° C. and bending molding. From a perspective of automotive light-weighting, the inner glass pane 23 is preferably a bent glass pane with a thickness less than or equal to 1.6 mm. In the disclosure, it is further found that a better Head up display effect can be obtained by using a thinner inner glass pane 23 when the transparent nano film 3 is deposited on the fourth surface 232 of the inner glass pane 23. The inner glass pane 23 preferably has a thickness ranging from 0.7 mm to 1.2 mm. The inner glass pane 23 may be made of chemically strengthened soda-lime-silica glass, chemically strengthened aluminosilicate glass, chemically strengthened borosilicate glass, body strengthened soda lime silicate glass, body strengthened aluminosilicate glass, or body strengthened borosilicate glass. In the disclosure, the chemical strengthening is mainly to produce a higher surface stress on a glass surface accompanied with a certain stress layer depth through exchange of ions with different ionic radii on the glass surface, thereby improving a strength of the glass in terms of mechanical property. In the disclosure, the body strengthened glass refers to raw glass that is neither physically nor chemically strengthened and can be directly matched with another glass to form laminated glass, where quality of the laminated glass meets a standard of automotive laminated glasses, such as GB9656-2016 Automotive Safety Glass in China.

### EMBODIMENTS

The following will list some embodiments of the disclosure for further illustration, where the disclosure is not limited to the following embodiments.

The following will illustrate Head up display systems in embodiments 1 to 15 and Head up display systems in comparative embodiments 1 to 3 of the disclosure. In each of embodiments 1 to 15 and comparative embodiments 1 to 3, a projection light source is a thin transistor film-liquid crystal display (TFT-LCD) projector with LED backlight, which can generate P-polarized light and further includes multiple reflection mirrors. A display image that can be observed by an observer can be the most clear by adjusting a position of the projection light source and an incident direction of exited light.

In the P-polarized light 11 incident on the transparent nano film 3, T1 is a proportion of near-red light with the wavelengths ranging from 580 nm to 680 nm, and T2 is a proportion of near-blue light with the wavelengths ranging from 420 nm to 470 nm, where T1 and T2 are calculated respectively according to the following expressions:

$$T 1 = \frac{k {\int }_{580}^{680} S ( λ ) * ( \overline{X} ( λ ) + \overline{Y} ( λ ) + \overline{Z} ( λ ) ) * d λ}{k {\int }_{380}^{780} S ( λ ) * ( \overline{X} ( λ ) + \overline{Y} ( λ ) + \overline{Z} ( λ ) ) * d λ} \\ T 2 = \frac{k {\int }_{420}^{470} S ( λ ) * ( \overline{X} ( λ ) + \overline{Y} ( λ ) + \overline{Z} ( λ ) ) * d λ}{k {\int }_{380}^{780} S ( λ ) * ( \overline{X} ( λ ) + \overline{Y} ( λ ) + \overline{Z} ( λ ) ) * d λ} ,$$

where k is an adjustment factor, R(λ) is a spectral reflectivity of an object, S(λ) is relative spectral power distribution of a light source, X̅(λ), Y̅(λ), and Z̅(λ) are spectral tri-stimulus values calculated from the CIE standard observer, and dλ is a wavelength interval.

R1 is a near-red light reflectivity at the wavelengths ranging from 580 nm to 680 nm of the laminated glass with the transparent nano film 3, and R2 is near-blue light reflectivity at wavelengths ranging from 420 nm to 470 nm of the laminated glass with the transparent nano film 3, where R1 and R2 are measured and calculated according to international organization for standardization (ISO) 9050.

### Embodiments 1 to 5 and Comparative Embodiment 1

In the disclosure, embodiments 1 to 5 and comparative embodiment 1 are obtained by designing a film structure of the transparent nano film and adjusting a value of T1/T2 of the P-polarized light incident on the transparent nano film.

Laminated glass: green glass (2.1 mm)/PVB (0.76 mm)/clear glass (2.1 mm)/transparent nano film

Transparent nano film: clear glass/SiN (41.4 nm)/TiOₓ (48.9 nm)/SiN (13.3 nm)/SiO₂ (112 nm)

Embodiment 1: T1/T2 of the P-polarized light incident is equal to 0.8.

Embodiment 2: T1/T2 of the P-polarized light incident is equal to 0.7.

Embodiment 3: T1/T2 of the P-polarized light incident is equal to 0.6.

Embodiment 4: T1/T2 of the P-polarized light incident is equal to 0.5.

Embodiment 5: T1/T2 of the P-polarized light incident is equal to 0.4.

Comparative embodiment 1: the P-polarized light incident is white light generated by the projection light source without light filtering or color filtering processing.

In embodiments 1 to 5 and comparative embodiment 1, the Head up display system projects the P-polarized light generated by the projection light source at an angle of incidence of 55°, 60°, 65°, 70°, and 75°. A target image presented is observed from a direction of an angle of reflection corresponding to the angle of incidence. Whether a Head up display image is reddish or yellowish is determined according to a standard that the target image is a white facula, and a red-green-blue (RGB) value of the white facula is (255, 255, 255). Observation results are recorded in Table 1.

TABLE 1
quality of Head up display images in embodiments 1 to 5 and comparative embodiment 1

| angle of | | comparative | embodiment | embodiment | embodiment | embodiment | embodiment |
|---|---|---|---|---|---|---|---|
| incidence | R1/R2 | embodiment 1 | 1 | 2 | 3 | 4 | 5 |
| 55° | 1.72 | reddish- | white | white | white | white | white |
| | | yellowish | | | | | |
| 60° | 1.90 | reddish- | slightly | white | white | white | white |
| | | yellowish | yellowish | | | | |
| 65° | 1.77 | reddish- | slightly | white | white | white | white |
| | | yellowish | yellowish | | | | |
| 70° | 1.51 | Severe | white | white | white | white | white |
| | | yellowish | | | | | |
| 75° | 1.29 | Severe | white | white | white | white | white |
| | | yellowish | | | | | |

As can be seen from Table 1, R1/R2 of the laminated glass with the transparent nano film ranges from 1.29 to 1.90. In comparative embodiment 1, the target image is presented in reddish-yellowish or severe yellowish when the white light generated by the projection light source without light filtering or color filtering processing is incident at 55°, 60°, 65°, 70°, and 75°. In embodiments 1 to 5, the target image is presented as the standard white facula without being reddish or yellowish by using P-polarized light incident with T1/T2 ranging from 0.4 to 0.8. In embodiment 1, the target image is presented in slightly yellowish when the P-polarized light is incident at 60° and 65°, but being reddish is significantly eliminated, and being slightly yellowish will not affect an observation effect of Head up display images.

### Embodiments 6 to 10 and Comparative Embodiment 2

In the disclosure, embodiments 6 to 10 and comparative embodiment 2 are obtained by designing a film structure of the transparent nano film and adjusting a value of T1/T2 of the P-polarized light incident on the transparent nano film.

Laminated glass: green glass (2.1 mm)/PVB (0.76 mm)/clear glass (0.7 mm)/transparent nano film

Transparent nano film: clear glass/ZnSnOₓ (24.8 nm)/SiO₂ (13.8 nm)/ZrN (10.2 nm)/TiOₓ (51.7 nm)/ZrN (13 nm)/SiO₂ (116 nm)

Embodiment 6: T1/T2 of the P-polarized light incident is equal to 0.8.

Embodiment 7: T1/T2 of the P-polarized light incident is equal to 0.7.

Embodiment 8: T1/T2 of the P-polarized light incident is equal to 0.6.

Embodiment 9: T1/T2 of the P-polarized light incident is equal to 0.5.

Embodiment 10: T1/T2 of the P-polarized light incident is equal to 0.4.

Comparative embodiment 2: the P-polarized light incident is white light generated by the projection light source without light filtering or color filtering processing.

In embodiments 6 to 10 and comparative embodiment 2, the Head up display system projects the P-polarized light generated by the projection light source at an angle of incidence of 55°, 60°, 65°, 70°, and 75°. A target image presented is observed from a direction of an angle of reflection corresponding to the angle of incidence. Whether a Head up display image is reddish or yellowish is determined according to a standard that the target image is a white facula, and an RGB value of the white facula is (255, 255, 255). Observation results are recorded in Table 2.

TABLE 2
quality of Head up display images in embodiments 6 to 10 and comparative embodiment 2

| angle of | | comparative | embodiment | embodiment | embodiment | embodiment | embodiment |
|---|---|---|---|---|---|---|---|
| incidence | R1/R2 | embodiment 2 | 6 | 7 | 8 | 9 | 10 |
| 55° | 1.41 | Severe | white | white | white | white | white |
| | | yellowish | | | | | |
| 60° | 1.47 | Severe | slightly | white | white | white | white |
| | | yellowish | yellowish | | | | |
| 65° | 1.38 | Severe | slightly | white | white | white | white |
| | | yellowish | yellowish | | | | |
| 70° | 1.25 | Severe | white | white | white | white | white |
| | | yellowish | | | | | |
| 75° | 1.14 | Severe | white | white | white | white | white |
| | | yellowish | | | | | |

As can be seen from Table 2, R1/R2 of the laminated glass with the transparent nano film ranges from 1.14 to 1.47. In comparative embodiment 2, the target image is presented in severe yellowish when the white light generated by the projection light source without light filtering or color filtering processing is incident at 55°, 60°, 65°, 70°, and 75°. In embodiments 6 to 10, the target image is presented as the standard white facula without being yellowish by using P-polarized light incident with T1/T2 ranging from 0.4 to 0.8. In embodiment 6, the target image is presented in slightly yellowish when the P-polarized light is incident at 60° and 65°, but being slightly yellowish will not affect an observation effect of Head up display images.

### Embodiments 11 to 15 and Comparative Embodiment 3

In the disclosure, embodiments 11 to 15 and comparative embodiment 3 are obtained by designing a film structure of the transparent nano film and adjusting a value of T1/T2 of the P-polarized light incident on the transparent nano film.

Laminated glass: green glass (2.1 mm)/PVB (0.76 mm)/clear glass (1.6 mm)/transparent nano film

Transparent nano film: clear glass/SiN (15.4 nm)/TiOₓ (35.1 nm)/SiO₂ (14.5 nm)/TiOₓ (9.4 nm)/SiN (9.0 nm)/SiO₂ (108.4 nm)

Embodiment 11: T1/T2 of the P-polarized light incident is equal to 0.8.

Embodiment 12: T1/T2 of the P-polarized light incident is equal to 0.7.

Embodiment 13: T1/T2 of the P-polarized light incident is equal to 0.6.

Embodiment 14: T1/T2 of the P-polarized light incident is equal to 0.5.

Embodiment 15: T1/T2 of the P-polarized light incident is equal to 0.4.

Comparative embodiment 3: the P-polarized light incident is white light generated by the projection light source without light filtering or color filtering processing.

In embodiments 11 to 15 and comparative embodiment 3, the Head up display system projects the P-polarized light generated by the projection light source at an angle of incidence of 55°, 60°, 65°, 70°, and 75°. A target image presented is observed from a direction of an angle of reflection corresponding to the angle of incidence. Whether a Head up display image is reddish or yellowish is determined according to a standard that the target image is a white facula, and an RGB value of the white facula is (255, 255, 255). Observation results are recorded in Table 3.

TABLE 3
quality of Head up display images in embodiments 11 to 15 and comparative embodiment 3

| angle of | | comparative | embodiment | embodiment | embodiment | embodiment | embodiment |
|---|---|---|---|---|---|---|---|
| incidence | R1/R2 | embodiment 3 | 11 | 12 | 13 | 14 | 15 |
| 55° | 1.14 | Severe | white | white | white | white | white |
| | | yellowish | | | | | |
| 60° | 1.25 | Severe | white | white | white | white | white |
| | | yellowish | | | | | |
| 65° | 1.23 | Severe | white | white | white | white | white |
| | | yellowish | | | | | |
| 70° | 1.15 | Severe | white | white | white | white | white |
| | | yellowish | | | | | |
| 75° | 1.07 | Severe | white | white | white | white | white |
| | | yellowish | | | | | |

As can be seen from Table 3, R1/R2 of the laminated glass with the transparent nano film ranges from 1.07 to 1.25. In comparative embodiment 3, the target image is presented in severe yellowish when the white light generated by the projection light source without light filtering or color filtering processing is incident at 55°, 60°, 65°, 70°, and 75°. In embodiments 11 to 15, the target image is presented as the standard white facula without being yellowish by using P-polarized light incident with T1/T2 ranging from 0.4 to 0.8.

The above specifically illustrates the Head up display system in the disclosure, and contents of the specific implementations illustrated above are not to limit the disclosure. Any improvements, equivalent modification, and arrangements made according to the technical points shall belong to the scope of protection of the disclosure.

A Head up display system for higher-quality HUD images is provided in the disclosure, which aims to solve a technical problem of Head up display images that are prone to deficiencies such as being reddish or yellowish.

To this end, a Head up display system is provided in the disclosure. The Head up display system includes a projection light source and laminated glass. The laminated glass includes an outer glass pane, an inner glass pane, and an intermediate adhesive layer sandwiched between the outer glass pane and the inner glass pane. The Head up display system further includes a transparent nano film, where the transparent nano film is deposited on a surface of the inner glass pane away from the intermediate adhesive layer. The transparent nano film includes at least one laminated structure consisting of a high refractive-index layer/a low refractive-index layer, where the high refractive-index layer/the low refractive-index layer is deposited sequentially outwards from the surface of the inner glass pane. The high refractive-index layer has a refractive index greater than or equal to 1.8, and the low refractive-index layer has a refractive index less than or equal to 1.6. The projection light source is configured to generate P-polarized light, where the P-polarized light is incident on the transparent nano film at an angle of incidence ranging from 55° to 75°. The laminated glass with the transparent nano film has a reflectivity for the P-polarized light greater than or equal to 8%. A ratio of near-red light reflectivity R1 at wavelengths ranging from 580 nm to 680 nm of the laminated glass with the transparent nano film to near-blue light reflectivity R2 at wavelengths ranging from 420 nm to 470 nm of the laminated glass with the transparent nano film is R1/R2=1.0˜2.0.

Preferably, in the P-polarized light incident on the transparent nano film, a ratio of proportion T1 of near-red light with the wavelengths ranging from 580 nm to 680 nm to proportion T2 of near-blue light with the wavelengths ranging from 420 nm to 470 nm is T1/T2=0.1˜0.9.

Preferably, a difference between a refractive index of the intermediate adhesive layer and a refractive index of the inner glass pane is less than or equal to 0.1.

Preferably, the intermediate adhesive layer has a wedge-shaped cross-sectional profile, and the wedge-shaped cross-sectional profile has a wedge angle ranging from 0.01 milli-radians (mrad) to 0.18 mrad.

Preferably, the laminated glass with the transparent nano film has the reflectivity for the P-polarized light greater than or equal to 15%.

Preferably, the laminated glass with the transparent nano film has the reflectivity for the P-polarized light greater than or equal to 20%.

Preferably, at least one high refractive-index layer has a refractive index greater than or equal to 2.5 and a thickness ranging from 45 nm to 75 nm.

Preferably, at least one high refractive-index layer includes at least two high refractive-index sub-layers, where at least one of the at least two high refractive-index sub-layers has a refractive index greater than or equal to 2.5, and at least another of the at least two high refractive-index sub-layers has a refractive index ranging from 1.8 to 2.2.

Preferably, at least one high refractive-index layer includes two first high refractive-index sub-layers and one second high refractive-index sub-layer. Each of the two first high refractive-index sub-layers has a refractive index ranging from 1.8 to 2.2, and the second high refractive-index sub-layer has a refractive index greater than or equal to 2.5. The second high refractive-index sub-layer is disposed between the two first high refractive-index sub-layers. More preferably, the refractive index of the second high refractive-index sub-layer is at least 0.5 greater than the refractive index of each of the two first high refractive-index sub-layers.

Preferably, in the P-polarized light incident on the transparent nano film, a ratio of proportion T1 of near-red light with the wavelengths ranging from 580 nm to 680 nm to proportion T2 of near-blue light with the wavelengths ranging from 420 nm to 470 nm is T1/T2=0.4˜0.8.

Preferably, the Head up display system further includes a light-filtering component, the light-filtering component is located on an optical path of the P-polarized light, and the light-filtering component has a transmittance for the P-polarized light greater than or equal to 80%.

Preferably, the Head up display system further includes a projection control system, the projection control system is used to control the projection light source to generate the P-polarized light, and the projection control system is configured to perform a color filtering processing algorithm.

Preferably, the outer glass pane is a bent glass pane with a thickness greater than or equal to 1.8 mm, and the inner glass pane is a bent glass pane with a thickness less than or equal to 1.6 mm.

Preferably, the inner glass pane has a thickness ranging from 0.7 mm to 1.2 mm, and the inner glass pane is made of a chemically strengthened soda-lime-silica glass, a chemically strengthened aluminosilicate glass, a chemically strengthened borosilicate glass, an body strengthened soda lime silicate glass, an body strengthened aluminosilicate glass, or an body strengthened borosilicate glass.

Preferably, the ratio of the near-red light reflectivity R1 to the near-blue light reflectivity R2 is R1/R2=1.07˜1.9.

The Head up display system in the disclosure can generate clear HUD images without visual ghosting, and eliminate deficiencies of the HUD images such as being reddish or yellowish, which can obtain higher-quality Head up display images. Furthermore, the Head up display system in the disclosure can generate the Head up display images in neutral color, and the Head up display images can be more colorful to implement full-color display, for example, to display marks or symbols in different colors such as red, green, blue, yellow, orange, or white in a Head up display image at the same time. Moreover, the Head up display system in the disclosure can also implement full-color display at a lower cost, thereby reducing a cost of a selected projection light source.

What is claimed is:

1. A Head up display system, comprising:
a projection light source;
laminated glass comprising an outer glass pane, an inner glass pane, and an intermediate adhesive layer sandwiched between the outer glass pane and the inner glass pane; and
a transparent nano film deposited on a surface of the inner glass pane away from the intermediate adhesive layer and comprising at least one laminated structure each consisting of a high refractive-index layer and a low refractive-index layer, wherein the high refractive-index layer and the low refractive-index layer are deposited sequentially outwards from the surface of the inner glass pane, the high refractive-index layer has a refractive index greater than or equal to 1.8, and the low refractive-index layer has a refractive index less than or equal to 1.6, wherein
the projection light source is configured to generate P-polarized light, the P-polarized light is incident on the transparent nano film at an angle of incidence ranging from 55° to 75°, and the laminated glass with the transparent nano film has a reflectivity for the P-polarized light greater than or equal to 8%; and
for the laminated glass with the transparent nano film, a ratio of near-red light reflectivity R1 at wavelengths ranging from 580 nm to 680 nm to near-blue light reflectivity R2 at wavelengths ranging from 420 nm to 470 nm is R1/R2=1.0˜2.0.

2. The Head up display system of claim 1, wherein in the P-polarized light incident on the transparent nano film, a ratio of proportion T1 of near-red light with the wavelengths ranging from 580 nm to 680 nm to proportion T2 of near-blue light with the wavelengths ranging from 420 nm to 470 nm is T1/T2=0.1˜0.9.

3. The Head up display system of claim 1, wherein a difference between a refractive index of the intermediate adhesive layer and a refractive index of the inner glass pane is less than or equal to 0.1.

4. The Head up display system of claim 1, wherein the intermediate adhesive layer has a wedge-shaped cross-sectional profile, and the wedge-shaped cross-sectional profile has a wedge angle ranging from 0.01 milli-radians (mrad) to 0.18 mrad.

5. The Head up display system of claim 1, wherein the laminated glass with the transparent nano film has the reflectivity for the P-polarized light greater than or equal to 15%.

6. The Head up display system of claim 1, wherein the laminated glass with the transparent nano film has the reflectivity for the P-polarized light greater than or equal to 20%.

7. The Head up display system of claim 1, wherein at least one high refractive-index layer has a refractive index greater than or equal to 2.5 and a thickness ranging from 45 nm to 75 nm.

8. The Head up display system of claim 1, wherein at least one high refractive-index layer comprises at least two high refractive-index sub-layers, at least one of the at least two high refractive-index sub-layers has a refractive index greater than or equal to 2.5, and at least another of the at least two high refractive-index sub-layers has a refractive index ranging from 1.8 to 2.2.

9. The Head up display system of claim 1, wherein at least one high refractive-index layer comprises two first high refractive-index sub-layers and one second high refractive-index sub-layer disposed between the two first high refractive-index sub-layers, each of the two first high refractive-index sub-layers has a refractive index ranging from 1.8 to 2.2, the second high refractive-index sub-layer has a refractive index greater than or equal to 2.5.

10. The Head up display system of claim 9, wherein the refractive index of the second high refractive-index sub-layer is at least 0.5 greater than the refractive index of each of the two first high refractive-index sub-layers.

11. The Head up display system of claim 1, wherein in the P-polarized light incident on the transparent nano film, a ratio of proportion T1 of near-red light with the wavelengths ranging from 580 nm to 680 nm to proportion T2 of near-blue light with the wavelengths ranging from 420 nm to 470 nm is T1/T2=0.4˜0.8.

12. The Head up display system of claim 1, further comprising a light-filtering component, wherein the light-filtering component is located on an optical path of the P-polarized light, and the light-filtering component has a transmittance for the P-polarized light greater than or equal to 80%.

13. The Head up display system of claim 1, further comprising a projection control system configured to:
control the projection light source to generate the P-polarized light; and
perform a color filtering algorithm on the P-polarized light generated from the projection light source.

14. The Head up display system of claim 1, wherein the outer glass pane is a bent glass pane with a thickness greater than or equal to 1.8 mm, and the inner glass pane is a bent glass pane with a thickness less than or equal to 1.6 mm.

15. The Head up display system of claim 1, wherein the inner glass pane has a thickness ranging from 0.7 mm to 1.2 mm, and the inner glass pane is made of chemically strengthened soda-lime-silica glass, chemically strengthened aluminosilicate glass, chemically strengthened borosilicate glass, body strengthened soda lime silicate glass, body strengthened aluminosilicate glass, or body strengthened borosilicate glass.

16. The Head up display system of claim 1, wherein the ratio of the near-red light reflectivity R1 to the near-blue light reflectivity R2 is R1/R2=1.07˜1.9.

17. The Head up display system of claim 1, wherein the low refractive-index layer includes at least two low refractive-index sub-layers.

18. The Head up display system of claim 1, wherein the high refractive-index layer is made of at least one of:
oxides of zinc, stannum, titanium, niobium, zirconium, nickel, indium, aluminium, cerium, tungsten, molybdenum, antimony, or bismuth or mixtures thereof, or nitrides or nitrogen oxides of silicon, aluminium, zirconium, yttrium, cerium, or lanthanum or mixtures thereof.

19. The Head up display system of claim 1, wherein the low refractive-index layer is made of at least one of silicon dioxide, aluminium oxide or mixtures thereof.
